(19) United States
(12) Patent Application Publication
(10) Pub. No.: US 2024/0380811 A1
(43) Pub. Date: Nov. 14, 2024

(54) SYSTEM AND METHOD FOR SIGNALING THROUGH DATA STORAGE

(71) Applicant: Twilio Inc., San Francisco, CA (US)

(72) Inventors: Carl Olivier, London (GB); Sergei Zolotarjov, Tallinn (EE); Mihails Velenko, Tallinn (EE); Devid Liik, Tallinn (EE); Artyom Tyazhelov, Tallinn (EE)

(73) Assignee: Twilio Inc., San Francisco, CA (US)

(21) Appl. No.: 18/781,887

(22) Filed: Jul. 23, 2024

Related U.S. Application Data
(63) Continuation of application No. 17/649,108, filed on Jan. 27, 2022, now Pat. No. 12,081,616.
Application No. 17/649,108 is a continuation of application No. 16/730,626, filed on Dec. 30, 2019, now Pat. No. 11,265,367.
Application No. 16/730,626 is a continuation of application No. 15/914,401, filed on Mar. 7, 2018, now Pat. No. 10,560,516.
Application No. 15/914,401 is a continuation of application No. 15/154,700, filed on May 13, 2016, now Pat. No. 9,948,703.
(60) Provisional application No. 62/265,557, filed on Dec. 10, 2015.
(60) Provisional application No. 62/163,270, filed on May 18, 2015.
(60) Provisional application No. 62/161,724, filed on May 14, 2015.
(60) Provisional application No. 62/161,719, filed on May 14, 2015.

(51) Int. Cl. H04L 67/10; H04L 67/1095

(52) U.S. Cl. CPC H04L 67/10; H04L 67/1095

(57) ABSTRACT

An application platform system and method. A data synchronization instance manages a reference state object for a data synchronization system (DSS) account. A first local state object is stored at a first application system. The first application system receives update notifications provided by the DSS. A second local state object is stored at a second application system. The second application system receives update notifications provided by the DSS. An application instruction of the first application system is transformed into a state update, and the first local state object is modified to include the state update. The state update is provided to the DSS via a local update notification. The reference state object is modified to include the state update. The state update is provided to the second application system via a reference update notification. The second local state object is modified to include the state update.

### CROSS-REFERENCE TO RELATED APPLICATIONS

This application is a Continuation application under 35 USC § 120 of U.S. patent application Ser. No. 17/649,108 entitled “System and Method for Signaling Through Data Storage,” filed on Jan. 27, 2022, which is a Continuation application under 35 USC § 120 of U.S. patent application Ser. No. 16/730,626 entitled “System And Method For Signaling Through Data Storage,” filed on Dec. 30, 2019, which is a continuation of U.S. patent application Ser. No. 15/914,401, filed May 7, 2018, which is a continuation of U.S. patent application Ser. No. 15/154,700, filed May 13, 2016, which claims the benefit of U.S. Provisional Application Ser. No. 62/265,557, filed on Dec. 10, 2015, U.S. Provisional Application Ser. No. 62/163,270, filed on May 18, 2015, U.S. Provisional Application Ser. No. 62/161,724, filed on May 14, 2015, and U.S. Provisional Application Ser. No. 62/161,719, filed on May 14, 2015, all of which are incorporated in their entirety by this reference.

### TECHNICAL FIELD

This invention relates generally to the communication field, and more specifically to a new and useful system and method for signaling through data storage in the communication field.

### BACKGROUND

The explosion of mobile devices hasn't replaced other types of devices from use. Instead, today's world increasingly sees users with many devices, using them interchangeably to accomplish tasks. On the way to work users check email and chat rooms on mobile phones, and then at work users transition to laptops to continue working. When users enter a conference room, they may transition again to a different machine, but in modern apps the expect context to be maintained across those devices. Building out applications with such robust multi-modal accessibility is challenging and time consuming process. Additionally, many new applications depend on establishing various forms of communication, often real-time messaging communication. However, building such technical solutions is complicated and time consuming. Thus, there is a need in the communication field to create a new and useful system and method for signaling through data storage. This invention provides such a new and useful system and method.

### BRIEF DESCRIPTION OF THE DRAWINGS

FIG. 1 is a schematic representation of a system, in accordance with embodiments;

FIG. 2 is a communication flow diagram of data synchronization between multiple clients, in accordance with embodiments;

FIG. 3 is a schematic representation of the technology layers employed in a system, in accordance with embodiments;

FIG. 4 is a flow diagram representation of a method, in accordance with embodiments;

FIGS. 5A-5C are schematic representations of systems, in accordance with embodiments;

FIG. 6 is a sequence diagram representation of a method, in accordance with embodiments;

FIGS. 7A-7B are a sequence diagram representations of a method, in accordance with embodiments;

FIG. 8 is a sequence diagram representation of a method, in accordance with embodiments;

FIG. 9 is an architecture diagram of a data synchronization system, in accordance with embodiments; and

FIG. 10 is an architecture diagram of an application system, in accordance with embodiments.

### DETAILED DESCRIPTION

The following description of preferred embodiments of the invention is not intended to limit the invention to these preferred embodiments, but rather to enable any person skilled in the art to make and use this invention.

### 1. System for Signaling Through Data

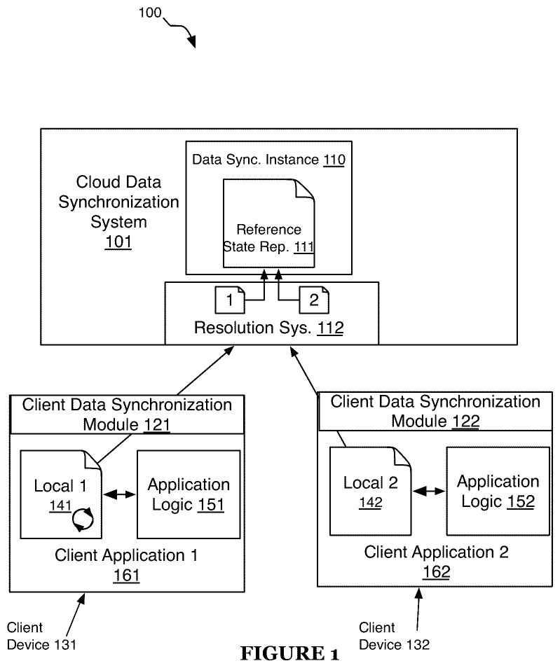

As shown in FIG. 1, in some embodiments, a system 100 for signaling through data storage of a preferred embodiment includes a cloud data synchronization system 101 that creates a data synchronization instance 110 to coordinate state management of a set of client devices (devices 131 and 132) with client data synchronization modules (121 and 122). The system 100 functions to provide an alternative approach to signaling between client devices (client devices 131, 132). In some implementations, the system 100 enables an approach to signaling that involves a client (131, 132) accessing a locally stored state representation object (141, 142). In some implementations, the data synchronization instance 110 of the system 100 then synchronizes the state representation object (141, 142) between clients (131, 132). In some implementations, the system 100 is implemented in part through a highly available, cloud-based state management system that handles the ingestion of objects and provides the capability to distribute objects to interested parties. The system 100 can remove much of the complexity and cost of an application developer goes through in building a product with client-managed state. The system 100 may additionally address some of the potential challenges of client-managed state machines such as consistency and flexibility in updating the client.

As shown in the embodiment of FIG. 1, the cloud data synchronization system 101 includes the data synchronization instance 110, and a resolution system 112. The data synchronization instance 110 includes a reference state representation object 111. The client device 131 includes a client data synchronization module 121 and a client application 161. The client device 131 also includes a local state representation object 141 and application logic 151. The client device 132 includes a client data synchronization module 122 and a client application 162. The client device 132 also includes a local state representation object 142 and application logic 152.

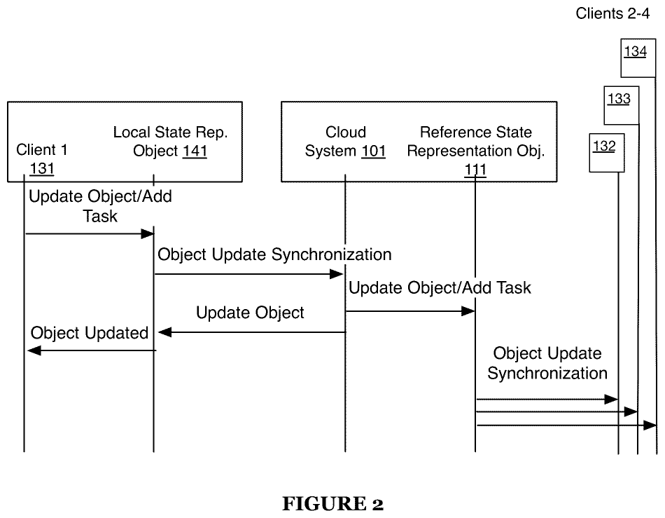

As shown in an exemplary application of the system 100 in FIG. 2, a client application (161 of the client device 131) writes data to the state representation object 141. The data represents how the client application 161 wants to update the state. In some implementations, the client application 161 adds a message to a chat conversation. In some implementations, the client application 161 writes directly to the state representation object 141 or uses a framework (such as an application framework). The system 100 automatically synchronizes the desired state changes through the cloud data synchronization system 101. If the desired state change conflicts with the reference state representation object 111, the conflicts are resolved. Then the cloud data synchronization system 101 synchronizes the updated state to a set of clients (132) that are subscribed to updates to that state representation object 111. The set of clients (132) then updates their state to reflect the synchronized update of their local state representation objects (142).

The cloud data synchronization system 101 functions to provide a network accessible resource to manage data synchronization. The cloud data synchronization system 101 can serve as the source of truth concerning state information. Clients (131, 132) synchronize with the cloud data synchronization system 101 rather than resolving various updates from multiple clients to determine their own state. In some implementations, the cloud data synchronization system 101 is hosted in a cloud-based, distributed computing infrastructure. In some implementations, the cloud data synchronization system 101 is hosted on any suitable computing infrastructure. In some implementations, the cloud data synchronization system 101 is accessible over the internet, a local network, or any suitable data connection. In some implementations, the data synchronization system 101 is implemented ad-hoc between multiple clients, where a master client device may run a client-based implementation of the data synchronization system.

In some implementations, the cloud data synchronization system 101 is part of a multi-tenant system wherein multiple and distinct entities can build applications and/or services utilizing the system 101 while sharing common computing resources. In some implementations, the multi-tenant cloud data synchronization system includes an accounting system that partitions usage and configuration by accounts and optionally sub-accounts of parent accounts. For example, an application developer can build a data synchronization solution for a first mobile application, and a second developer can build a data synchronization solution for a different and distinct mobile application. Authentication, configuration, usage, data, billing, and/or other properties of the system can be kept distinct. In some implementations, the system 101 is implemented as a single-tenant system.

In some implementations, the cloud data synchronization system 101 includes a data synchronization storage system, which functions to store data, records, and other information that relates to data synchronization instances (e.g., 110).

In some implementations, the cloud data synchronization system 101 includes at least one programmatic interface. In some implementations, the programmatic interface includes an API. In some implementations, the API is a RESTful API but may alternatively be any suitable API such as SOAP or custom protocol. The RESTful API works according to an application layer request and response model. An application layer request and response model may use an HTTP-based protocol (HTTP or HTTPS), SPDY, or any suitable application layer protocol. Herein, HTTP may be used, but should not be interpreted as being limited to the HTTP protocol. HTTP requests (or any suitable request communication) to the communication platform preferably observe the principles of a RESTful design. RESTful is understood in this document to describe a Representational State Transfer architecture as is known in the art. The RESTful HTTP requests are preferably stateless, thus each message communicated contains all necessary information for processing the request and generating a response. The API service can include various resources, which act as endpoints that can act as a mechanism for specifying requested information or requesting particular actions. The resources can be expressed as URI's or resource paths. The RESTful API resources can additionally be responsive to different types of HTTP methods such as GET, Put, POST and/or DELETE. In some implementations, the data synchronization instances (e.g., 110), aspects of the data synchronization instances, and/or other aspects can be manipulated and accessed as RESTful API resources. In some implementations, the programmatic interface includes a client interface, which enables clients or other devices to interface with the cloud data synchronization system 101. In some implementations, the client interface is a restricted or private API or any suitable programmatic interface. In some implementations, client devices use the public API using a client SDK, library, or native implementation. In some implementations, the system 101 includes an administration user interface. An account or subaccount holder can use the administration user interface to manage data synchronization and state management.

The data synchronization instance 110 functions to encapsulate and characterize the management of data synchronization between clients (e.g., 131, 132). In some implementations, the data synchronization instance 110 is preferably accessible through the programmatic interface(s). In some implementations, a data synchronization instance is uniquely mapped to a session state. In some implementations, an application uses multiple data synchronization sessions, which correspond to multiple, different communication sessions, threads, or channels. For example, an IP messaging application can use a different data synchronization instance for each chat thread.

In some implementations, a data synchronization instance includes option configuration. In some implementations, various options enable control over data handling, access permissions, validation rules, and/or other forms of customization. In some implementations, data handling enables various rules to be enforced related to how the data is stored such as setting how data is stored geographically, how long data is persisted, and/or other suitable options. In some implementations, permissions are set on how the data synchronization instance can be accessed and/or modified. For example, access permissions can be set so that a first set of entities is permitted to edit state while a second set of clients can only access the state. In some implementations, the data synchronization instance 110 manages the state representation object 111 that is synchronized between clients. In some implementation, the state representation object (111, 141, 142) is stored and/or represented in any suitable form. In some implementations, the state representation object (111, 141, 142) is a text-based document that expresses information through a suitable data structure object. In some implementations, the state representation object (111, 141, 142) is one of JSON, plain text, SML, base64 encoded items, or any suitable document type. In some implementations, the state representation object (111, 141, 142) uses key value stores to characterize various properties of the state. In some implementations, standardized protocol/syntax is expected for a state representation object (111, 141, 142). In some implementations, a subset of basic keys and values are required, recommended, and/or optional. For example, a state representation object can follow a basic pattern for indicating how state updates are time stamped and/or prioritized so that conflicts are resolved. In some implementations, at least a portion of the state representation object (111, 141, 142) is highly customized to adapt to the particular application and/or use case. For example, various keys and hierarchical data structures can be used to represent an application's particular state.

In some implementations, the cloud data synchronization system 101 includes a resolution system 112, which functions to process state updates to a data synchronization instance and resolve inconsistencies. In some implementations, a set of rules and/or heuristics are built into the resolution system 112 so that inconsistent state updates made from various clients can be resolved. In some implementations, the resolved state and/or any suitable resolution alerts is communicated to clients (131, 132) through the state representation object (111, 141, 142).

The client data synchronization modules 121, 122 function to act as a client tool for interacting with the data representation object. In some implementations, the client data synchronization modules 121, 122 operate as a component of an application or service on a client device (131, 132). In some implementations, a client device (e.g., 131, 132) is at least one of a phone, a wearable computer, a personal computer, a browser, an IoT device, and/or any suitable computing device. In some implementations, client data synchronization model (121, 122) is part of an SDK, a library, or any development tool. In some implementations, client data synchronization model (121, 122) is provided for a variety of popular device clients (e.g. Android, iPhone, in-browser JavaScript) and server clients (e.g. NodeJS, Ruby on Rails, Java . . . ) languages/platforms. From the developer perspective, a set of tools is provided for interacting with a local state representation object. The synchronization of the state representation object (141, 142) is transparent to the application (161, 162).

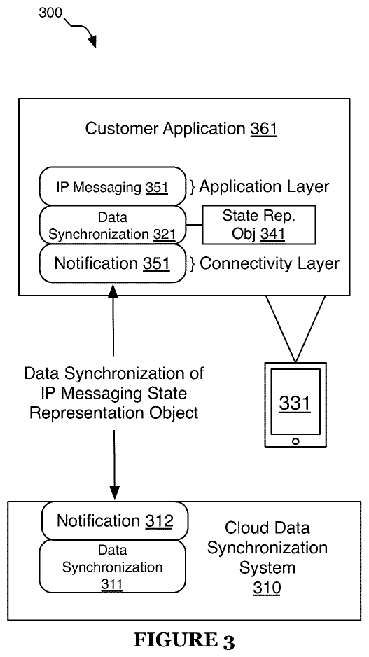

The system 100 can be usable without any knowledge of underlying storage, retrieval, and synchronization mechanisms. The system 100 and in particular the data synchronization elements described above can be used with additional technology layers to further power application functionality as shown in FIG. 3. In some embodiments, the system 300 of FIG. 3 is similar to the system 100 of FIG. 1.

In some implementations, the system 331 is similar to the client device 131 of FIG. 1. In some implementations, the cloud data synchronization system 310 is similar to the cloud data synchronization system 101 of FIG. 1.

In some implementations, the system 331 includes an application layer 351 that operates on top of the data synchronization layer 321. In some implementations, the application layer 351 is customized for business logic and functionality specific to the use case. In some implementations, the application layer 351 is an IP messaging layer. In some implementations, as part of an IP messaging layer, a client SDK or library is provided that interfaces with a state representation object 341 to support general IP messaging operations. In some implementations, the application 361 uses the IP messaging layer 351 to create channels, add members, and/or send/read messages. During these operations, the IP messaging layer 351 uses the data synchronization layer 321 to update and read from the data representation object 341 and simultaneously the data representation object 341 is synchronized to various clients as part of a data synchronization instance. In some implementations, the application layer 351 is an IoT (internet of things) device management layer. In some implementations, common IoT tasks and operations are represented in a higher-level abstraction layer that utilizes the underlying data synchronization layer to coordinate operation of multiple IoT devices.

In some implementations, the system 331 includes a connectivity layer 351 that is used by the data synchronization layer 321 to coordinate communication with the cloud 310 and client devices. In some implementations, the connectivity layer 351 is a notification layer that enables push notifications. In some implementations, the connectivity layer 351 is a polling layer that manages how clients and the cloud 310 periodically request updates.

In some implementations, the data synchronization layer 311 is similar to the data synchronization layer 321. In some implementations, the data synchronization layer 311 is similar to the data synchronization instance 110 of FIG. 1. In some implementations, the data synchronization layer 311 is constructed to update and read from a reference data representation object of the cloud data synchronization system 310. In some implementations, the data synchronization layer 311 is constructed to synchronize the reference data representation object of the cloud data synchronization system 310 to various clients as part of a data synchronization instance of the system 310. In some implementations, the data synchronization layer 311 is constructed to update and read from a reference data representation object of the cloud data synchronization system 310, and simultaneously synchronize the reference data representation object of the cloud data synchronization system 310 to various clients as part of a data synchronization instance of the system 310.

In some implementations, the data synchronization instance of the system 310 is similar to the data synchronization instance 110 of FIG. 1.

In some implementations, the reference data representation object of the cloud data synchronization system 310 is similar to the reference state representation object 111 of FIG. 1.

In some implementations, the connectivity layer 312 of the system 310 is similar to the connectivity layer 351. In some implementations, the connectivity layer 312 is used by the data synchronization layer 311 to coordinate communication with the client devices (331). In some implementations, the connectivity layer 312 is a notification layer that enables push notifications. In some implementations, the connectivity layer 312 is a polling layer that manages how clients and the cloud 310 periodically request updates.

### 2. Method for Signaling Through Data Synchronization

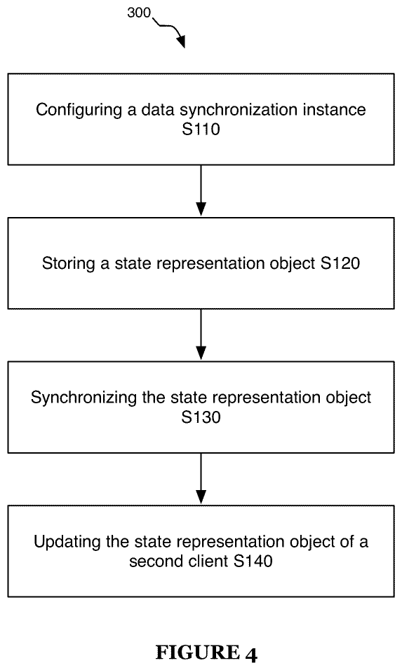

As shown in FIG. 4, a method 400 for signaling through data synchronization of a preferred embodiment can include configuring a data synchronization instance S110, storing a state representation object S120, synchronizing the state representation object S130, and updating the state representation object of a second client S140. The method 400 functions to use synchronization of documents that characterize application state to facilitate communication between a set of client devices (e.g., 131, 132). The method 400 provides an alternative approach to communicating between clients (e.g., 131, 132).

The method 400 can be used in a variety of scenarios. In some implementations, in a first scenario, the method 400 is used to synchronize multiple devices (e.g., 131, 132) of a single account. For example, a mobile phone application and a desktop browser version of some service can be made to be eventually consistence by building on top of the data synchronization layer (e.g., 321). In some implementations, in a second scenario, the method 400 is used in synchronizing communication between multiple devices (e.g., 131, 132) of different accounts. For example, a chat program and the state of the chat can be synchronized between two accounts using the method 400. The state representation object is preferably updated in substantially real-time such that real-time communication can be conveyed. In some implementations, the state representation object of a client device (e.g., 141, 142 of FIG. 1, 341 of FIG. 3) is updated in substantially real-time such that real-time communication can be conveyed. In some implementations, the state representation object of the cloud data synchronization system (e.g., 111 of FIG. 1) is updated in substantially real-time such that real-time communication can be conveyed.

In some embodiments, the method 400 is implemented by a system substantially similar the system 100. In some embodiments, the method 400 is implemented by a system substantially similar the system 300. In some embodiments, the method 400 is implemented by any suitable system. In some implementations, the method 400 is implemented by a system similar to the system 300, and the method 400 is used in combination with an application layer (similar to 351) where the synchronization of state is used to provide an IP messaging framework. In some implementations, the method 400 is implemented by a system similar to the system 300, and the method 400 is used in combination with an application layer (similar to 351) where the synchronization of state is used to provide an IoT device management framework. In some implementations, the method 400 is implemented by a system similar to the system 300, and the method 400 is used in combination with an application layer (similar to 351) where the synchronization of state is used to provide any suitable application framework. In some implementations, the method 400 is used with a connectivity layer (similar to 351, 312) to facilitate how notifications and information is relayed between clients and/or the cloud system.

Block S110, which includes configuring a data synchronization instance (e.g., 110 of FIG. 1), functions to establish resource through which data can be synchronized. In some implementations, configuring a data synchronization instance includes creating the data synchronization instance and setting any customization of the instance. In some implementations, a data synchronization instance is created by an account (of the cloud data synchronization system) prior to when data synchronization capabilities are required, which may be in anticipation of usage by an account or when an account submits a request to begin some task that will utilize data synchronization. In some implementations, a data synchronization instance is created through an administrator user interface. In some implementations, a data synchronization instance is created through a programmatic interface (e.g., REST API). In some implementations, a data synchronization instance is created through a client application request (which may use a private or public programmatic interface). In some implementations, a data synchronization instance is identifiable. In some implementations, a unique identifier is automatically generated during creation. In some implementations, a friendly name is used. In some implementations, the friendly name (and the identifier) is scoped globally within at least one of the platform, within an account or subaccount scope, or with any suitable scope. In some implementations, clients use the identifier when addressing state updates and synchronization. Clients using the same identifier will share information through their respective state representation objects (e.g., 141, 142). In some implementations, a single data synchronization instance (e.g., 110) is used to characterize multiple state representation objects (e.g., 111). This architecture may be used so that various customization options can be simply controlled and managed through a single data synchronization instance (e.g., 110). In some implementations, a data synchronization instance (e.g., 110) is used for the synchronization of a single state representation object (e.g., 111).

In some implementations, setting customization of the instance (e.g., 110) customizes various options of the data synchronization instance (e.g., 110). In some implementations, setting customization includes setting geographic data storage options. In some implementations, geographic data storage options determine which region or regions are used for storing data. In some implementations, the geographic data storage options provide a blacklist of countries, regions, or locations where data should not be stored. In some implementations, setting customization includes setting data encryption settings. In some implementations, data encryption is managed on the edge clients. In some implementations, data encryption options are enabled in association with the data synchronization instance (e.g., 110). In some implementations, setting customization includes setting permissions of the data synchronization instance (e.g., 110), which functions to provide an access control list to enforce policy on interactions with the data synchronization instance. In some implementations, the permissions define the read permissions, write permissions, and/or other management permissions. In some implementations, permissions are set by at least one of account, device identity, device properties, and/or any suitable rule. For example, one account may only have read access permissions and so clients of that account can be driven by the state of the data synchronization instance but may not be able to alter state.

Block S120, which includes storing a state representation object, functions to use a local object (e.g., 141, 142) as a conduit for implying state update requests with connected clients (e.g., 131, 132). In some implementations, storing a state representation object includes storing a reference state representation object (e.g., 111 of FIG. 1) at the cloud data synchronization system (e.g., 101, 310). In some implementations, storing a state representation object includes storing a reference state representation object (e.g., 111 of FIG. 1) of a data synchronization instance (e.g., 110) of the cloud data synchronization system (e.g., 101, 310). In some implementations, the state representation object (e.g., 141, 142) is stored locally within a client device (e.g., 131, 132). For example, an application may store and maintain a local representation of the state representation object. In some implementations, the method 400 includes providing a client data synchronization module (e.g., 121, 122 of FIG. 1), which functions to provide a tool for interacting with a state representation object (e.g., 141, 142). In some implementations, manipulation of the state representation object (e.g., 141, 142) through the client data synchronization module (e.g., 121, 122) allows the state representation object (e.g., 141, 142) to be updated in a controlled and consistent manner. In some implementations, updated state information is added to the state representation object (e.g., 141, 142) along with supporting meta data. For example, a timestamp synchronized to a reference clock can be added to updated information to facilitate resolving conflicts. However, alternative approaches may enable direct manipulation of the state representation object. In some implementations, actions taken to the state representation object (e.g., 141, 142) are performed without consideration of synchronizing state.

In some implementations, a local state representation object (e.g., 141, 142) is stored for each client application (e.g., 161, 162). In some implementations, a state representation object is stored in the cloud data synchronization system (e.g., 101, 310). In some implementations, the cloud data synchronization system (e.g., 101, 310) includes a single reference source of truth representation (e.g., 111). In some implementations, the cloud data synchronization system (e.g., 101, 310) includes various instances of the state representation object, which depend on the reference source. In some implementations, a local state representation object (e.g., 141, 142) is created in association with an identifier of a data synchronization instance (e.g., 110). State representation objects of other client instances (e.g., 132, 134 of FIG. 2) that use a corresponding identifier will also be synchronized with the reference representation object (e.g., 111). In some implementations, local storage of the state representation object (e.g., 141, 142) functions to provide recovery during connectivity interruption. If a client device loses network access, the application can continue to update state. Updates made while offline are eventually resolved when connectivity is re-established.

In some implementations, the method 400 includes providing an application layer (e.g., 151, 152 of FIG. 1, 351 of FIG. 3) to interface with the state representation object (e.g., 141, 142, 341), which functions to abstract management of the state representation object into a set of application-specific interactions. In some implementations, an application-specific SDK or library is provided that utilizes a state representation object (e.g., 141, 142, 341). In some implementations, an IP messaging application layer (e.g., 351) provides higher-level business level to the management of chat channels, channel participants, and message history. From the developer perspective, instructions are made to create and join a chat channel and to add a message. Instructions are transformed into state updates that are characterized in the state representation object. In some implementations the application layers include at least one of an IoT device management layer, a video conferencing layer, a customer service layer, a gaming layer, and/or any suitable application layer.

Block S130, which includes synchronizing the state representation object, functions to coordinate communication of state updates. Changes to the local state representation object (e.g., 141, 142, 341) are detected within the client (e.g., 131, 132, 331) and then uploaded to the cloud data synchronization system (e.g., 101, 310). Similarly, outside changes to a state representation object (e.g., 142) by another client (e.g., 132) are transferred and applied to the local version (e.g., 141) on the client (e.g., 131). In some implementations, updates are transmitted to the remote cloud system (e.g., 101, 310) in response to a change. In some implementations, a minimum time since the last update is enforced to limit the number of notifications transmitted to the cloud system (e.g., 101, 310). In some implementations, updates are transmitted periodically. In some implementations, the cloud system (e.g., 101, 310) requests updates from the client (e.g., 131, 132, 331). In other words, the cloud system (e.g., 101, 310) polls the clients (e.g., 131, 132, 331) for updates. Any suitable approach may be used in how and when updates are synchronized between clients and the cloud system. Synchronizing the state representation object additionally includes distributing state information updates to a client (e.g., 131, 132, 331). In some implementations, updates are transmitted back to the clients (e.g., 131, 132) in response to updates made to the reference representation (e.g., 111) of state information in the cloud (e.g., 110). In some implementations, the updates are transferred and handled through the client data synchronization module (e.g., 121, 122) in block S140 such that the end application logic (e.g., 151, 152, 162, 162) built by the developer does not need to process incoming updates—the updates are automatically synchronized. For example, if the client is a user application, the view of the application can be reactive to changes in the state representation object such that any synchronized updates can be automatically reflected in the state of the user application.

In some implementations, the full state representation object is transferred between the clients and cloud system. In some implementations, the differences or partial representations are transmitted to reduce the amount of data transferred during each update. In some implementations, synchronizing the state representation object includes the cloud system (e.g., 101, 310) tracking the version of state representation for associated clients. The version information can be used to determine which clients need updates.

In some implementations, the method 400 includes providing a connectivity layer (e.g., 351), which functions to provide a framework that manages how the information and alerts are transmitted between the clients and the cloud system. In some implementations, the connectivity layer (e.g., 351) uses any suitable communication transport layer such as a HTTP-based protocol (HTTP or HTTPS), SPDY, or any suitable transport protocol. In some implementations, the connectivity layer (e.g., 351) facilitates push notifications where updates can be actively pushed or transmitted to appropriate entities. In some implementations, in the case of sending an update from the cloud system to a client, the update is accompanied by a notification such as a push notification displayed within the operating system of the client device. In some implementations, the connectivity layer specifies a polling process in which the clients and/or the cloud system poll for updates.

In some implementations, synchronizing the state representation object includes resolving conflicts. In some implementations, the cloud system receives updated state information from a plurality of clients. In some implementations, updates to the state representation may conflict with updates from one or more other clients. For example, if one client made changes during a temporary lack of connectivity, those changes could be in conflict with changes made by other clients. In some implementations, the cloud system processes the various updates from clients and determines a resolution that incorporates the changes into a single state representation. In some implementations, time-based prioritization of updates are used. In some implementations, rules are defined on how particular updates are prioritized and resolved. In some implementations, rules are pre-configured as part of the configuration of a data synchronization instance. In some implementations, resolving conflicts includes retrieving resolution guidance from an outside source. For example, a configured callback URI can be messaged over HTTP/S with relevant information. In some implementations, the relevant information includes current reference state information and the conflicting state updates. In some implementations, the system of the callback URI sends a response that includes instructions on how to resolve the conflict.

Block S140, which includes updating the operational state of a second client based on the state representation object, functions to make an application or service react to synchronized changes to the state representation object. In some implementations, a client data synchronization module (e.g., 121, 122) includes a framework for signaling when the state representation object (e.g., 141, 142) was updated. In some implementations, how the state representation object (e.g., 141, 142) was updated is communicated. In some implementations, the application logic (e.g., 151, 152) is built to automatically respond to changes in the state representation object (e.g., 141, 142).

The use of synchronized state representation data can provide an alternative to request response signaling in a communication application. All the state information that is to be communicated between clients is preferably represented within the state representation object (e.g., 141, 142), and so inbound communications or state changes are communicated through the state representation object (e.g., 141, 142) as opposed to signaling messages transmitted through some protocol.

As one exemplary use case, the method for signaling through data synchronization can be applied to a messaging application. In some implementations, the messaging application is designed using a data synchronization and IP messaging framework that facilitates the use of a data representation object (e.g., 141, 142, 341) in synchronization with a cloud system (e.g., 101, 310). In some implementations, a first client application (e.g., 161) creates a new chat channel to communicate with the other channels. In some implementations, a data synchronization instance (e.g., 110) is created and a set of client applications preferably joins the data synchronization instance. In some implementations, a local data representation object (e.g., 141, 142, 341) or file is established on each of the client devices (e.g., 131, 132, 331). In some implementations, the state of the local data representation object (e.g., 141, 142) represents the properties of the channel such as channel name, members, channel permissions, and/or other settings. These channel properties are synchronized across all the local data representation objects. Then a client application will post a new message. That client will add the new message as an element in the state representation object, and the state representation object will be synchronized with the cloud system. The cloud system will update the reference version of the state representation object and transmit the updated information to the other clients. In some implementations, the clients update their display to represent the new message. In some implementations, subsequent messages, media, and/or other channel interactions is communicated using the state representation object.

### 3. Application Platform Systems

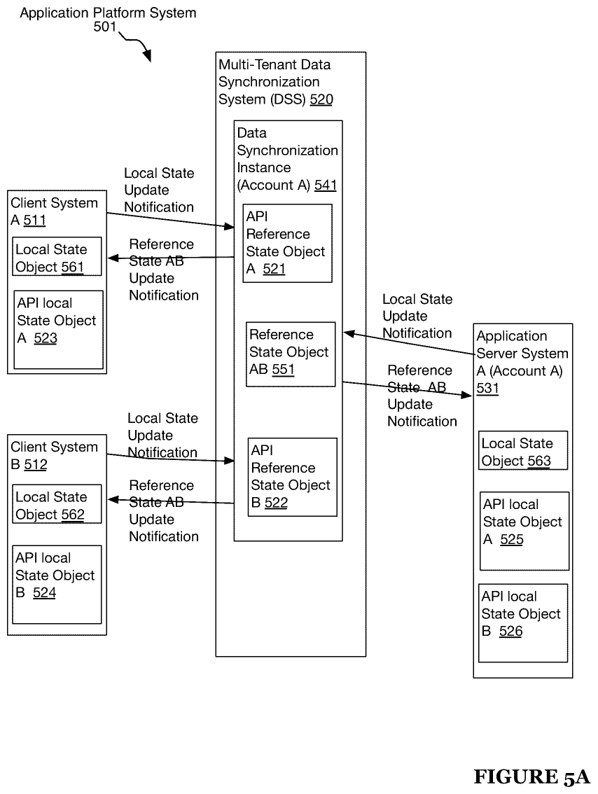

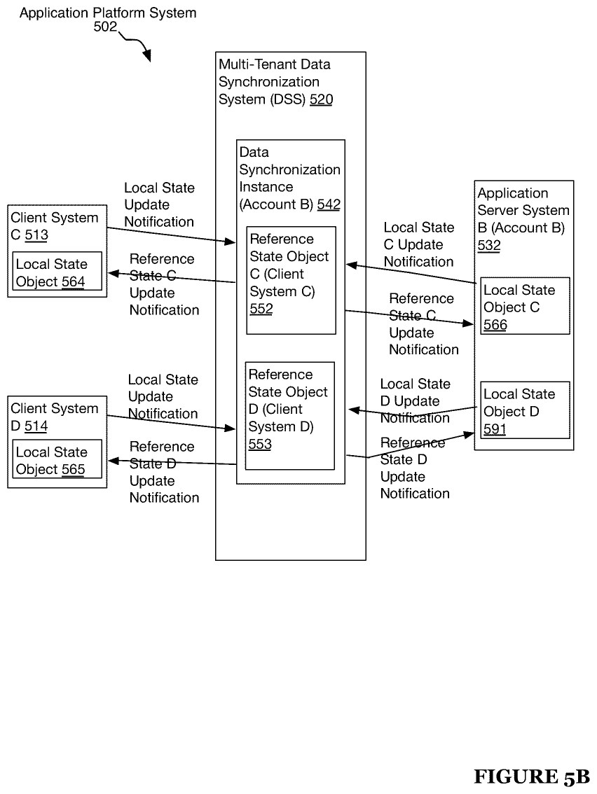

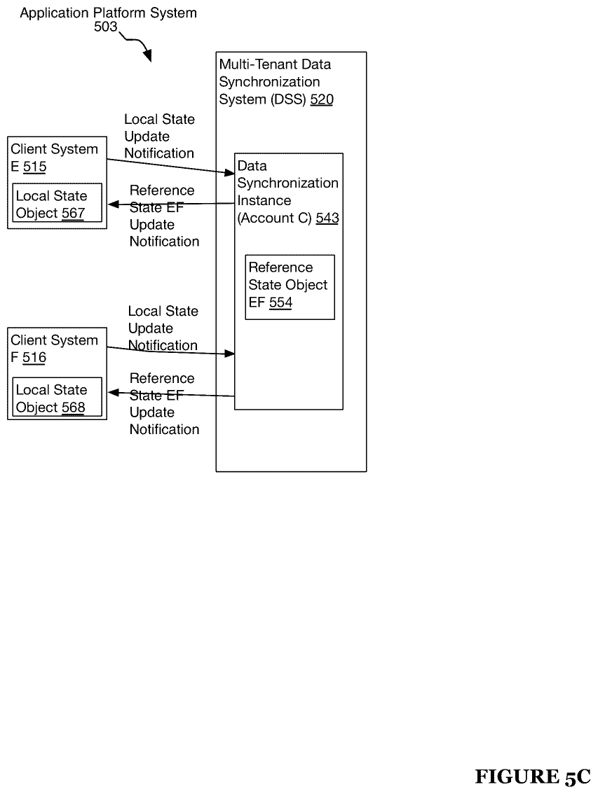

FIGS. 5A-C are schematic representations of application platform systems 501-503, in accordance with embodiments. In some implementations, the state objects of FIGS. 5A-C (e.g., 521-526, 551-554, 561-568, 591) are files. In some implementations, the state objects of FIGS. 5A-C (e.g., 521-526, 551-554, 561-568, 591) are files stored in a file system. In some implementations, the state objects of FIGS. 5A-C (e.g., 521-526, 551-554, 561-568, 591) are text files. In some implementations, the state objects of FIGS. 5A-C (e.g., 521-526, 551-554, 561-568, 591) are human-readable files. In some implementations, the state objects of FIGS. 5A-C (e.g., 521-526, 551-554, 561-568, 591) are XML files.

### FIG. 5A

In some implementations, the application platform system 501 of FIG. 5A provides a service of the application server system 531 to client systems 511 and 512. In some implementations, the service of the application server system 531 is a communication service that provides for communication between the client system 511 and the client system 512. In some implementations, the service of the application server system 531 is a communication service that provides a chat session for communication between the client system 511 and the client system 512.

The application platform system 501 includes the client systems 511 and 512, the DSS 520, and the application server system 531.

The client system 511 includes a local client API state object 523 and a local communication state object 561. In some implementations, the local communication state object 561 is a chat channel state object. The client system 512 includes a local client API state object 524 and a local communication state object 562. In some implementations, the local communication state object 562 is a chat channel state object.

The DSS 520 includes a data synchronization instance 541 for an account of the DSS (“Account A”). The data synchronization instance 541 includes a reference API state object 521, a reference API state object 522, and a reference communication state object 551. In some implementations, the reference communication state object 551 is a chat channel state object.

The application server system 531 includes a local server API state object 525, a local server API state object 526, and a local communication state object 563. In some implementations, the local communication state object 563 is a chat channel state object.

In some implementations, the local communication state objects 561, 562 and 563 are synchronized with the reference communication state object 551. In some implementations, the local client API state object 523 and the local server API state object 525 are synchronized with the reference API state object 521. In some implementations, the local client API state object 524 and the local server API state object 526 are synchronized with the reference API state object 522. In some implementations, the local client API state object 523, the local server API state object 525, and the reference API state object 521 provide communication between the client system 511 and the application server system 531. In some implementations, the local client API state object 523, the local server API state object 525, and the reference API state object 521 provide communication of API requests and API responses of an API of the application server system 531 between the client system 511 and the application server system 531.

In some implementations, the local client API state object 524, the local server API state object 526, and the reference API state object 522 provide communication between the client system 512 and the application server system 531. In some implementations, the local client API state object 524, the local server API state object 526, and the reference API state object 522 provide communication of API requests and API responses of an API of the application server system 531 between the client system 512 and the application server system 531.

In some implementations, the state objects 523, 521 and 525 include API request data and API response data communicated between the client system 511 and the application server system 531. In some implementations, the state objects 524, 522 and 526 include API request data and API response data communicated between the client system 512 and the application server system 531. In some implementations, API request data includes at least one of: create new chat API request data, join chat request data, add participant request data, send message to chat request data. In some implementations, API response data includes at least one of: create new chat API response data, join chat response data, add participant response data, send message to chat response data.

In some implementations, create new chat API request data includes at least one of chat title and chat description. In some implementations, create new chat API response data includes at least one of request execution status, an identifier of a reference state object (e.g., 551) for the created chat, and a unique identifier of the chat channel.

In some implementations, join chat request data includes at least the unique identifier of the chat channel. In some implementations, join chat response data includes at least one of request execution status and an identifier of a reference state object (e.g., 551) for the joined chat.

In some implementations, add participant request data includes at least one of the unique identifier of the chat channel and a username of a participant to be added to the chat channel. In some implementations, add participant response data includes at least one of request execution status and an identifier of a reference state object (e.g., 551) for the chat.

In some implementations, send message to chat request data includes at least one of the unique identifier of the chat channel and a chat message. In some implementations, send message to chat response data includes at least one of request execution status and a unique identifier of the sent chat message.

In some implementations, the local communication state objects 561, 562 and 563 and the reference communication state object 551 provide communication between the client system 511 and the client system 512. In some implementations, the local communication state objects 561, 562 and 563 and the reference communication state object 551 provide chat channel communication between the client system 511 and the client system 512.

In some implementations, the state objects 561, 562, 563 and 551 include message data communicated between the client system 511 and the client system 512. In some implementations, the state objects 561, 562, 563 and 551 include chat channel state data for a chat channel in which the client system 511 and the client system 512 participate. In some implementations, the chat channel state includes chat messages of the chat channel. In some implementations, the chat channel state includes at least one of chat identifier, chat title, chat description, list of chat messages and their properties (e.g., sender, time stamp, read status), list of chat participants and their properties (e.g., role).

In some implementations, the client systems 511 and 512, the data synchronization instance 541, and the application server system 531 are associated with a first DSS account (e.g., “Account A”) of a plurality of accounts managed by an account system (not shown) of the DSS 520. In some implementations, the client systems 511 and 512, and the application server system 531 are systems of an account holder of a first DSS account (e.g., “Account A”) of a plurality of accounts managed by an account system (not shown) of the DSS 520. In some implementations, the client systems 511 and 512, and the application server system 531 are external to the DSS 520.

In some implementations, the client systems 511 and 512 are similar to the client systems 131 and 132 of FIG. 1. In some implementations, the client systems 511 and 512 are similar to the client system 331 of FIG. 3. In some implementations, the state objects 561, 562, 563, and 523-526 are similar to the state objects 141 and 142 of FIG. 1. In some implementations, the state objects 561, 562, 563, and 523-526 are similar to the state object 341 FIG. 3. In some implementations, the state objects 521, 522 and 551 are similar to the state object 111 of FIG. 1. In some implementations, the DSS 520 is similar to the cloud data synchronization system 101 of FIG. 1. In some implementations, the DSS 520 is similar to the cloud data synchronization system 310 of FIG. 3. In some implementations, the data synchronization instance 541 is similar to the data synchronization instance 110 of FIG. 1. In some implementations, the DSS 520 includes a resolution system similar to the resolution system 112 of FIG. 1. In some implementations, the application server system 531 is similar to the client devices 131 and 132 of FIG. 1. In some implementations, the application server system 531 is similar to the client device 331 of FIG. 3.

In some implementations, a first set of one or more data synchronization instances for the DSS account of the application server system 531 manages the reference communication state objects of the DSS account of the application server system 531, and a second set of one or more data synchronization instances for the DSS account of the application server system 531 manages the reference API state objects of the DSS account of the application server system 531. In some implementations, each state object of the DSS account of the application server system 531 is managed by a different data synchronization instance for the DSS account of the application server system 531.

In some implementations, the application server system 531 provides a plurality of communication channels, the application server system 531 includes a local communication state object (similar to 563) for each communication channel, and the DSS 520 includes a reference communication state object (similar to 551) for each communication channel. In some implementations, each communication channel is a chat channel. In some implementations, each reference communication state object for the DSS account of the application server system 531 is managed by a single data synchronization instance for the DSS account of the application server system 531. In some implementations, a plurality of data synchronization instances for the DSS account of the application server system 531 manage the plurality of reference communication state objects for the DSS account of the application server system 531.

### FIG. 5B

In some implementations, the application platform system 502 of FIG. 5B provides a service of the application server system 532 to client systems 513 and 514. In some implementations, the service of the application server system 532 is a cloud service, and the DSS 520 provides request/response communication between the client system 513 and the application server 532, and between the client system 514 and the application server 532.

The application platform system 502 includes the client systems 513 and 514, the DSS 520, and the application server system 532.

The client system 513 includes a local client API state object 564. The client system 514 includes a local client API state object 565.

The DSS 520 includes a data synchronization instance 542 for an account of the DSS (“Account B”). The data synchronization instance 542 includes a reference API state object 552 and a reference API state object 553.

The application server system 532 includes a local server API state object 566, and a local server API state object 591.

In some implementations, the local client API state object 564 and the local server API state object 566 are synchronized with the reference API state object 552. In some implementations, the local client API state object 565 and the local server API state object 591 are synchronized with the reference API state object 553.

In some implementations, the local client API state object 564, the local server API state object 566, and the reference API state object 552 provide communication between the client system 513 and the application server system 532. In some implementations, the local client API state object 564, the local server API state object 566, and the reference API state object 552 provide communication of API requests and API responses of an API of the application server system 532 between the client system 513 and the application server system 532.

In some implementations, the local client API state object 565, the local server API state object 591, and the reference API state object 553 provide communication between the client system 514 and the application server system 532. In some implementations, the local client API state object 565, the local server API state object 591, and the reference API state object 553 provide communication of API requests and API responses of an API of the application server system 532 between the client system 514 and the application server system 532.

In some implementations, the state objects 552, 564 and 566 include API request data and API response data communicated between the client system 513 and the application server system 532. In some implementations, the state objects 553, 565 and 591 include API request data and API response data communicated between the client system 514 and the application server system 532.

In some implementations, the client systems 513 and 514, the data synchronization instance 542, and the application server system 532 are associated with a second DSS account (e.g., “Account B”) of a plurality of accounts managed by an account system (not shown) of the DSS 520. In some implementations, the client systems 513 and 514, and the application server system 532 are systems of an account holder of a second DSS account (e.g., “Account B”) of a plurality of accounts managed by an account system (not shown) of the DSS 520. In some implementations, the client systems 513 and 514, and the application server system 532 are external to the DSS 520.

In some implementations, the client systems 513 and 514 are similar to the client systems 131 and 132 of FIG. 1. In some implementations, the client systems 513 and 514 are similar to the client system 331 of FIG. 3. In some implementations, the state objects 564, 565, 566 and 591 are similar to the state objects 141 and 142 of FIG. 1. In some implementations, the state objects 564, 565, 566 and 591 are similar to the state object 341 FIG. 3. In some implementations, the state objects 552 and 553 are similar to the state object 111 of FIG. 1. In some implementations, the data synchronization instance 542 is similar to the data synchronization instance 541. In some implementations, the application server system 532 is similar to the application server system 531.

In some implementations, the DSS 520 manages reference API state objects for a plurality of DSS accounts. In some implementations, the DSS 520 manages reference API state objects for a plurality of DSS accounts, and each DSS account is associated with at least one application server system that communicates API requests and responses of an API of the application server system with at least one client system by synchronizing local API state objects with the reference API state object managed by the DSS.

In some implementations, a plurality of client systems (e.g., the client system 513 and another client system, not shown) are constructed to synchronize their respective local client API state objects (e.g., 564) with the same reference API state object (e.g., 552). In some implementations, a first device (e.g., a mobile phone) used by a first user communicates with the application server system 532 via the DSS 520, and the DSS 520 stores the application state of the communication in the reference API state object 552 of the DSS; when the first user transitions to a second device (e.g., a laptop), the second device used by the first user accesses the reference API state object 552 of the DSS to obtain the user's application state. In this manner, application state can be maintained across a plurality of devices used by a user.

### FIG. 5C

In some implementations, the application platform system 503 of FIG. 5C provides communication between the client system 515 and the client system 516. In some implementations, the application platform system 503 of FIG. 5C provides peer-to-peer communication between the client system 515 and the client system 516. In some implementations, the application platform system 503 of FIG. 5C provides ad-hoc communication between the client system 515 and the client system 516. In some implementations, the application platform system 503 of FIG. 5C provides communication between the client system 515 and the client system 516, and the client system 515 and the client system 516 are both IoT devices. In some implementations, the application platform system 503 of FIG. 5C provides communication between the client system 515 and the client system 516, and the client system 515 and the client system 516 are both IoT devices each including an IoT management layer module.

The application platform system 503 includes the client systems 515 and 516, and the DSS 520.

The client system 515 includes a local communication state object 567. In some implementations, the local communication state object 567 is a chat channel state object. The client system 516 includes a local communication state object 568. In some implementations, the local communication state object 568 is a chat channel state object.

The DSS 520 includes a data synchronization instance 543 for an account of the DSS (“Account C”). The data synchronization instance 543 includes a reference communication state object 554. In some implementations, the reference communication state object 554 is a chat channel state object.

In some implementations, the local communication state objects 567 and 568 are synchronized with the reference communication state object 554.

In some implementations, the local communication state objects 567 and 568, and the reference communication state object 554 provide communication between the client system 515 and the client system 516. In some implementations, the local communication state objects 567 and 568, and the reference communication state object 554 provide chat channel communication between the client system 515 and the client system 516.

In some implementations, the client systems 515 and 516, and the data synchronization instance 543 are associated with a third DSS account (e.g., “Account C”) of a plurality of accounts managed by an account system (not shown) of the DSS 520. In some implementations, the client systems 515 and 516 are systems of an account holder of a third DSS account (e.g., “Account C”) of a plurality of accounts managed by an account system (not shown) of the DSS 520. In some implementations, the client systems 515 and 516 are external to the DSS 520.

In some implementations, the client systems 515 and 516 are similar to the client systems 131 and 132 of FIG. 1. In some implementations, the client systems 515 and 516 are similar to the client system 331 of FIG. 3. In some implementations, the state objects 567 and 568 are similar to the state objects 141 and 142 of FIG. 1. In some implementations, the state objects 567 and 568 are similar to the state object 341 FIG. 3. In some implementations, the state object 554 is similar to the state object 111 of FIG. 1. In some implementations, the DSS 520 is similar to the cloud data synchronization system 101 of FIG. 1. In some implementations, the DSS 520 is similar to the cloud data synchronization system 310 of FIG. 3. In some implementations, the data synchronization instance 543 is similar to the data synchronization instance 110 of FIG. 1. In some implementations, the DSS 520 includes a resolution system similar to the resolution system 112 of FIG. 1.

In some implementations, the DSS 520 manages reference communication state objects for a plurality of DSS accounts.

### 4. Application Platform Methods

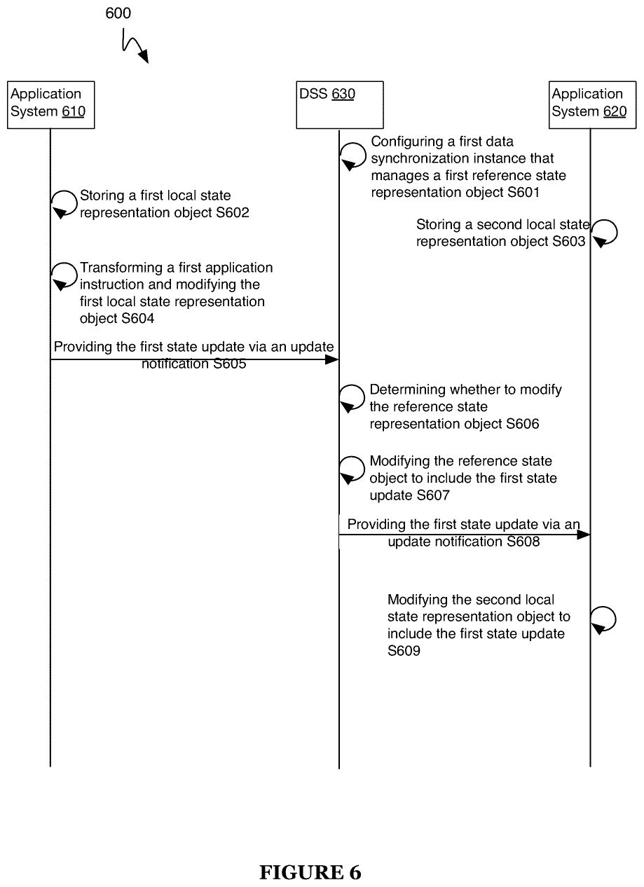

### FIG. 6

The method 600 of FIG. 6 is performed at an application platform system (e.g., 501-503 of FIGS. 5A-5C). In some implementations, the application platform system includes a first application system 610 (e.g., one of 511-516 and 531-532 of FIGS. 5A-C), a second application system 620 (e.g., a different one of 511-516 and 531-532 of FIGS. 5A-C), and a multi-tenant data synchronization system (DSS) 630 (e.g., 520 of FIG. 5). In some implementations, the first application system 610 is similar to at least one of 131 and 132 of FIG. 1, 331 of FIG. 3, and 511-516 and 531-532 of FIGS. 5A-C, and the second application system 620 is similar to at least one of 131 and 132 of FIG. 1, 331 of FIG. 3, and 511-516 and 531-532 of FIGS. 5A-C. In some implementations, the DSS 630 is similar to at least one of the cloud data synchronization system 101 of FIG. 1, the cloud data synchronization system 310 of FIG. 2, and the DSS 520 of FIGS. 5A-C.

In some embodiments, the method 600 includes: the DSS 630 configuring a first data synchronization instance (e.g., 541, 542, 543) for a first account of the DSS (e.g., “Account A”, “Account B”, “Account C”), responsive to a request provided by a system of the first account, wherein the first data synchronization instance manages a first reference state representation object (e.g., 521, 522, 551-554) for the first account at the DSS (process S601); the first application system 610 storing a first local state representation object (e.g., 523-526, 561-568, 591) that corresponds to the first reference state representation object of the DSS, wherein the first application system is constructed to receive first reference state representation object update notifications provided by the DSS (process S602); the second application system 620 storing a second local state representation object (e.g., 523-526, 561-568, 591) that corresponds to the first reference state representation object of the DSS, wherein the second application system is constructed to receive first reference state representation object update notifications provided by the DSS (process S603); the first application system 610 transforming a first application instruction of the first application system into a first state update, and modifying the first local state representation object to include the first state update (process S604); the first application system 610 providing at least the first state update of the modified first local state representation object to the DSS via a first local state representation object update notification (process S605); responsive to the first state update, the DSS 630 determining whether to modify the first reference state representation object of the DSS to include the first state update (process S606); responsive to a determination by the DSS to modify the first reference state representation object to include the first state update, the DSS 630 modifying the first reference state representation object to include the first state update (process S607); the DSS 630 providing at least the first state update to the second application system via a first reference state representation object update notification (process S608); and responsive to the first state update, the second application system 620 modifying the second local state representation object to include the first state update (process S609). The first application system 610 and the second application system 620 communicate by using the DSS.

In some embodiments, the method 600 includes: the second application system transforming a second application instruction of the second application system into a second state update, and modifying the second local state representation object to include the second state update; and the second application system providing at least the second state update of the modified second local state representation object to the DSS. The DSS determining whether to modify the first state representation object of the DSS to include the first state update includes: the DSS determining whether the first state update conflicts with the second state update; and responsive to a determination that the first state update conflicts with the second state update, the DSS resolving the conflict between the first state update and the second state update.

In some embodiments, the first application system is a client system (e.g., 511-516) that includes a first client application (e.g., 161, 162 of FIG. 1, 361 of FIG. 3), and the second application system is a client system (e.g., a different one of 511-516) that includes a second client application. In some embodiments, first client application and the second client application are chat client applications of a chat service provided by the system (e.g., 531) of the first account (e.g., “Account A”), the first application instruction is a chat client application instruction, and the chat service (e.g., a chat service of the server system 531) is constructed to receive first reference state representation object update notifications. In some embodiments, the chat client application instruction includes at least one of: an instruction to add a message to a chat channel, and an instruction to add a participant to a chat channel.

In some embodiments, the first application system is an application server system (e.g., 531-532) that includes a first application server, the first application server system is the system that provides the request to configure the first data synchronization instance (e.g., 541, 542) for the first account, the second application system is a client system (e.g., 511-514) that includes a first client application, and the first client application and the first application server communicate via the DSS 520.

In some embodiments, the first application system is a client system (e.g., 511-514) that includes a first client application, the second application system is an application server system (e.g., 531-532) that includes a first application server, at least one of the application server system and the client system is the system that provides the request to configure the first data synchronization instance (e.g., 541, 542) for the first account, and the first client application and the first application server communicate via the DSS 520. In some embodiments, the method 600 includes: the application server system (e.g., 531-532) determining whether the first state update corresponds to a command of the first application server; and responsive to a determination by application server system (e.g., 531-532) that the first state update corresponds to a command of the first application server, the application server system (e.g., 531-532) executing the command and providing a response to the client system via the DSS 520.

In some embodiments, the system of the first account provides the request to configure the first data synchronization instance via at least one of an administrator user interface and a programmatic interface. In some embodiments, the system of the first account is at least one of the first application system and the second application system.

In some embodiments, the DSS 520 configuring the first data synchronization instance (the process S601) includes: the DSS 520 configuring at least one option of the first data synchronization instance (e.g., 541-543), and the at least one option includes at least one of: a geographic data storage option, a data encryption setting, and a permission of the data synchronization instance.

In some embodiments, the first application system stores the first local state representation object (e.g., 523-526, 561-568 and 591) responsive to at least one of: a communication provided by the second application system, a communication provided by the DSS 520, a communication provided by the system of the first account, and an application instruction of a first application of the first application system.

In some embodiments, the first application system storing the first local state representation object (e.g., 523-526, 561-568 and 591) includes: storing the first local state representation object in association with an identifier of the first data synchronization instance (e.g., 541-543), and the second application system storing the second local state representation object includes: storing the second local state representation object in association with the identifier of the first data synchronization instance (e.g., 54-543). In some implementations, the first application system receives the identifier of the first data synchronization instance from at least one of: the second application system, the DSS 520, the system of the first account, and an application instruction of a first application of the first application system. In some implementations, the second application system receives the identifier of the first data synchronization instance from at least one of: the first application system, the DSS 520, the system of the first account, and an application instruction of a second application of the second application system.

In some embodiments, the first application system storing the first local state representation object includes: storing the first local state representation object (e.g., 523-526, 561-568 and 591) in association with an identifier of the first state representation object (e.g., one of 521, 522, 551-554) of the DSS 520, and the second application system storing the second local state representation object includes: storing the second local state representation object in association with the identifier of the first state representation object (e.g., one of 521, 522, 551-554) of the DSS 520.

In some implementations, the first application system receives the identifier of the first state representation object from at least one of: the second application system, the DSS 520, the system of the first account, and an application instruction of a first application of the first application system. In some implementations, the second application system receives the identifier of the first state representation object from at least one of: the first application system, the DSS 520, the system of the first account, and an application instruction of a second application of the second application system.

In some embodiments, the first application system is constructed to receive first reference state representation object update notifications provided by the DSS 520 via a push notification module (e.g., 351 of FIG. 3) of the first application system, and the second application system is constructed to receive first reference state representation object update notifications provided by the DSS 520 via a push notification module (e.g., 351 of FIG. 3) of the second application system. In some embodiments, the first application system is constructed to subscribe to first reference state representation object update notifications provided by the DSS 520 via the push notification module of the first application system, and the second application system is constructed to subscribe to first reference state representation object update notifications provided by the DSS 520 via the push notification module of the second application system.

In some implementations, the first application system is constructed to receive first reference state representation object update notifications provided by the DSS 520 via a polling module of the first application system that periodically requests first reference state representation object update notifications from the DSS, and the second application system is constructed to receive first reference state representation object update notifications provided by the DSS via a polling module of the second application system that periodically requests first reference state representation object update notifications from the DSS.

In some implementations, the DSS is external to each of the first application system and the second application system.

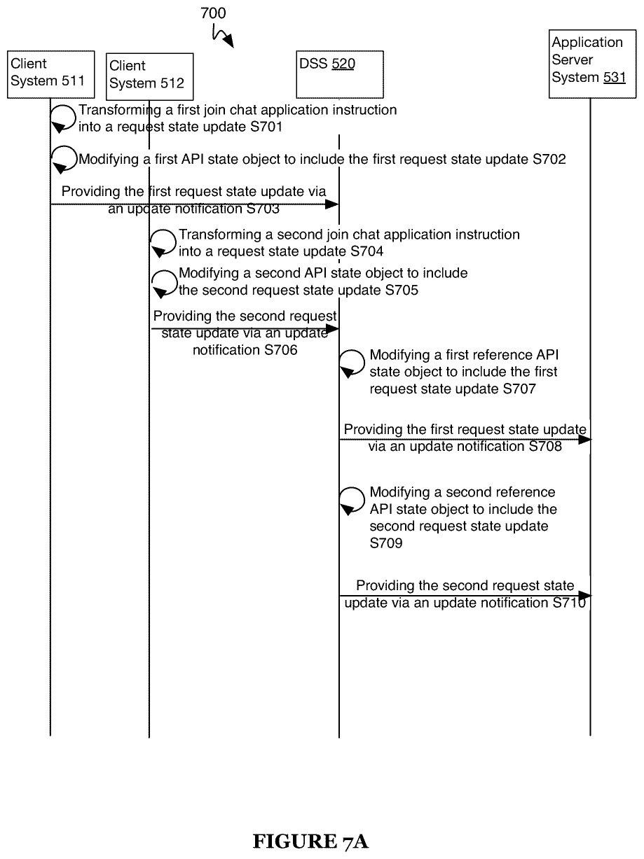

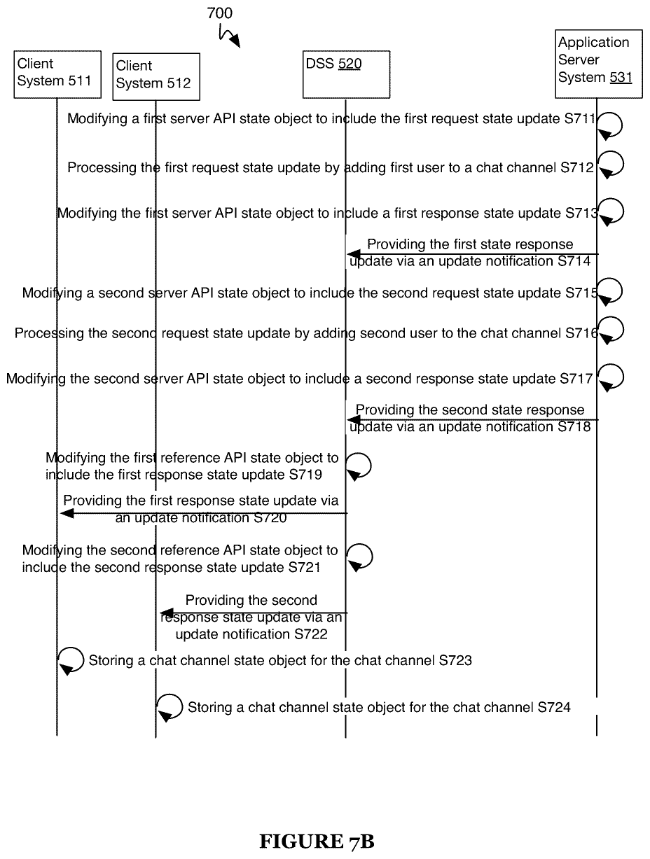

### FIG. 7

The method 700 of FIGS. 7A-B is performed at a chat system. In some implementations, the application platform system 501 of FIG. 5A is a chat system, and the method 700 is performed by the application platform system 501. In some implementations, the application platform system 501 includes a first chat client system (e.g., 511 of FIG. 5A), a second chat client system system (e.g., 512 of FIG. 5A), a multi-tenant data synchronization system (DSS) (e.g., 520 of FIG. 5A), and a chat application server system (e.g., the application server system 531 of FIG. 5A).

In some embodiments, the method 700 includes: the first chat client system 511 transforming a first chat client application instruction to join a first chat channel into a first request state update (process S701); the system 511 modifying a first local application programming interface (API) state object 523 stored at the first chat client system 511 to include the first request state update (process S702); the system 511 providing the first request state update to the DSS 520 via a first local API state update notification (process S703); the second chat client system 512 transforming a second chat client application instruction to join the first chat channel into a second request state update (process S704); the system 512 modifying a second local API state object 524 stored at the second chat client system 512 to include the second request state update (process S705); the system 512 providing the second request state update to the DSS via a second local API state update notification (process S706); the DSS 520 modifying a first reference API state object 521 stored at the DSS 520 to include the first request state update (process S707); the DSS 520 providing the first request state update to the chat application server system 531 via a first reference API state update notification (process S708); the DSS 520 modifying a second reference API state object 522 stored at the DSS 520 to include the second request state update (process S709); the DSS 520 providing the second request state update to the chat application server system 531 via a second reference API state update notification (process S710); the chat application server system 531 modifying a first local API state object 525 stored at the chat application server system 531 to include the first request state update (process S711); the system 531 processing the first request state update by updating first chat channel state of the first chat channel to include a user of the first chat client application (of the system 511) as a participant of the first chat channel (process S712); the system 531 modifying the first local API state object 525 stored at the chat application server system 531 to include a first response state update that includes an identifier for a first reference chat channel state object 551, wherein the first reference chat channel state object 551 includes the first chat channel state (process S713); the system 531 providing the first response state update to the DSS 520 via a third local API state update notification (process S714); the system 531 modifying a second local API state object 526 stored at the chat application server system 531 to include the second request state update (process S715); the system 531 processing the second request state update by updating first chat channel state of the first chat channel to include a user of the second chat client application (of the system 512) as a participant of the first chat channel (process S716); the system 531 modifying the second local API state object 526 stored at the chat application server system 531 to include a second response state update that includes the identifier for the first reference chat channel state object 551 (process S717); the system 531 providing the second response state update to the DSS 520 via a fourth local API state update notification (process S718); the DSS 520 modifying the first reference API state object 521 stored at the DSS 520 to include the first response state update (process S719); the DSS 520 providing the first response state update to the first chat client system 511 via a third reference API state update notification (process S720); the DSS 520 modifying the second reference API state object 522 stored at the DSS 520 to include the second response state update (process S721); the DSS 520 providing the second response state update to the second chat client system 512 via a fourth reference API state update notification (process S722); the first chat client system 511 storing a first local chat channel state object 561 in association with the identifier for the first reference chat channel state object 551 (process S723); and the second chat client system 512 storing a second local chat channel state object 562 in association with the identifier for the first reference chat channel state object 551 (process S724). The first chat client system 511 sends a message via the first chat channel by modifying the first local chat channel state object 561 which is synchronized with the second local chat channel state object 562 via the first reference chat channel state object 551. The second chat client system 512 sends a message via the first chat channel by modifying the second local chat channel state object 562 which is synchronized with the first local chat channel state object 561 via the first reference chat channel state object 551.

In some embodiments, the first chat client system 511, the second chat client system 512, the chat application server system 531, the first reference chat channel state object 551, the first local chat channel state object 561, the second local chat channel state object 562, the first reference API state object 521, the second reference API state object 522, the first local API state object 523, the second local API state object 524, the first local API state object 525, and the a second local API state object 526 are associated with a first DSS account (e.g., “Account A”) managed by an account system of the DSS 520.

In some implementations, the DSS 520 is constructed to resolve conflicting updates to the first reference chat channel state object 551 received from the first chat client system 511 and the second chat client system 512. In some implementations, the DSS is constructed to resolve conflicting updates to the first reference chat channel state object 551 received from the first chat client system 511 and the second chat client system 512 by using a resolution system similar to the resolution system 112 of FIG. 1.

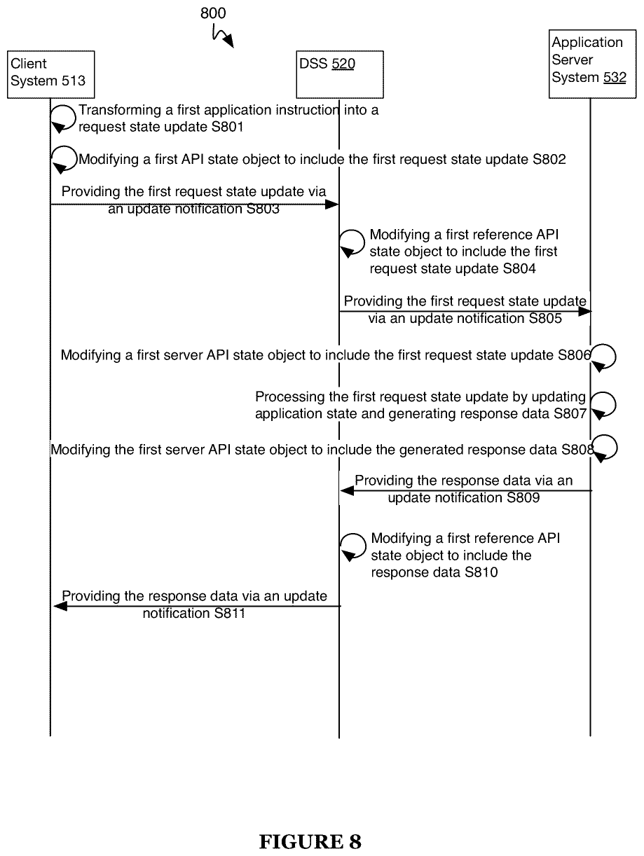

### FIG. 8

The method 800 of FIG. 8 is performed at an application platform system (e.g., 501-502 of FIGS. 5A-5B). In some implementations, the application platform system includes a first client system (e.g., 513 of FIG. 5B), a multi-tenant data synchronization system (DSS) (e.g., 520 of FIG. 5B), and a first application server system (e.g., 532 of FIG. 5B).

In some embodiments, the method 800 includes: the first client system 513 transforming a first application instruction of a first client application (e.g., an application similar to at least one of 161 and 162 of FIG. 1, and 361 of FIG. 3) of the first client system 513 into a first request state update (process S801); the system 513 modifying a first local client application programming interface (API) state object 564 stored at the first client system to include the first request state update (process S802); the system 513 providing the first request state update to the DSS 520 via a first local client API state update notification (process S803); the DSS 520 modifying a first reference API state object 552 stored at the DSS 520 to include the first request state update (process S804); the DSS 520 providing the first request state update to a first application server system 532 of the application platform system via a first reference API state update notification (process S805); the first application server system 532 modifying a first local server API state object 566 stored at the first application server system 532 to include the first request state update (process S806); the first application server system 532 processing the first request state update by updating first application state at the first application server system 532 for the first client application and generating first response data (process S807); the first application server system 532 modifying the first local server API state object 566 to include the generated first response data (process S808); the first application server system 532 providing the first response data to the DSS 520 via a first local server API state update notification (process S809); the DSS 520 modifying the first reference API state object 552 stored at the DSS 520 to include the first response data (process S810); and the DSS 520 providing the first response data to the first client system 513 via a second reference API state update notification (process S811).

In some embodiments, the first local client API state object 564 and the first local server API state object 566 are synchronized with the first reference API state object 552, and the first client system 513 and the first application server system 532 communicate by using the DSS 520. In some embodiments, the first local client API state object 564, the first reference API state object 552, and the first local server API state object 566 are associated with a first DSS account (e.g., “Account B”) of a plurality of accounts managed by an account system (not shown) of the DSS 520. In some embodiments, the first client system 513 and the first application server system 532 are systems of an account holder of the first DSS account (e.g., “Account B”).

In some implementations, the DSS 520 is external to each of the first client system 513 and the first application server system 532. In some implementations, the first client system 513 transforms the first state response update into an application callback of the first client application of the first client system 513.

### 5. System Architecture

### Data Synchronization System

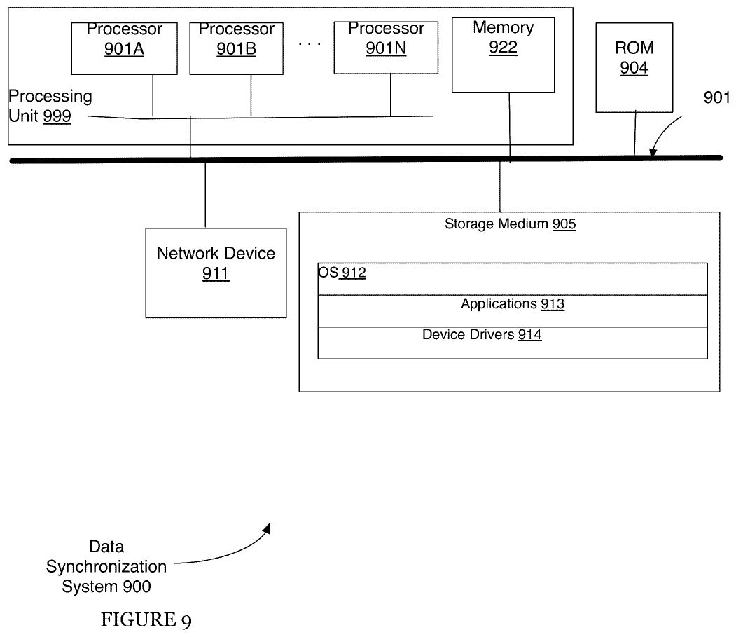

FIG. 9 is an architecture diagram of a data synchronization system (e.g., 101 of FIG. 1, 310 of FIG. 3, and 520 of FIGS. 5A-C) according to an implementation in which the system is implemented by a server device. In some implementations, the system is implemented by a plurality of devices. In some implementations, the system 900 is similar to the system 101 of FIG. 1. In some implementations, the system 900 is similar to the system 310 of FIG. 3. In some implementations, the system 900 is similar to the system 520 of FIGS. 5A-C.

The bus 901 interfaces with the processors 901A-901N, the main memory (e.g., a random access memory (RAM)) 922, a read only memory (ROM) 904, a processor-readable storage medium 905, and a network device 911. In some implementations, the system 900 includes at least one of a display device and a user input device.

The processors 901A-901N may take many forms, such as ARM processors, X86 processors, and the like.

In some implementations, the system (e.g., 520) includes at least one of a central processing unit (processor) and a multi-processor unit (MPU).

The processors 901A-901N and the main memory 922 form a processing unit 999. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more data synchronization instances.

The network adapter device 911 provides one or more wired or wireless interfaces for exchanging data and commands between the system (e.g., 520) and other devices, such as an external system (e.g., 511-516, 531, 532). Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory 922 (of the processing unit 999) from the processor-readable storage medium 905, the ROM 904 or any other storage location. During execution of these software programs, the respective machine-executable instructions are accessed by at least one of processors 901A-901N (of the processing unit 999) via the bus 901, and then executed by at least one of processors 901A-901N. Data used by the software programs are also stored in the memory 922, and such data is accessed by at least one of processors 901A-901N during execution of the machine-executable instructions of the software programs. The processor-readable storage medium 905 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 905 includes machine-executable instructions (and related data) for an operating system 912, software programs 913, and device drivers 914. The processor-readable storage medium 905 includes machine-executable instructions (and related data) for at least one data synchronization instance (e.g., 541-543). In some implementations, the processor-readable storage medium 905 includes instructions (and related data) for at least one of a notification module (e.g., 312 of FIG. 3) and a resolution system (e.g., 112 of FIG. 1).

### Application System

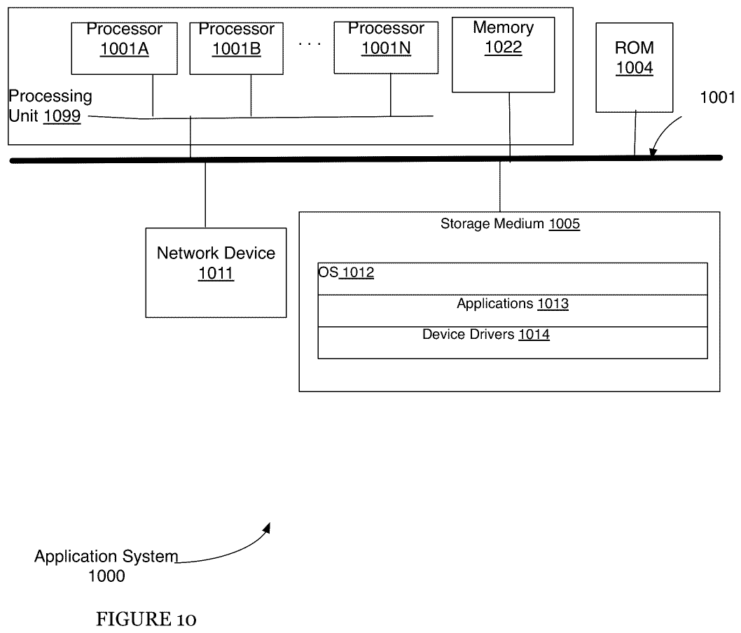

FIG. 10 is an architecture diagram of an application system 1000 (e.g., one of 131, 132 of FIG. 1, 331 of FIG. 3, 511-516 of FIGS. 5A-C, and one of 531-532 of FIGS. 5A-B) according to an implementation in which the application system is implemented by a computing device. In some implementations, the application system is implemented by a plurality of devices.

The bus 1001 interfaces with the processors 1001A-1001N, the main memory (e.g., a random access memory (RAM)) 1022, a read only memory (ROM) 1004, a processor-readable storage medium 1005, and a network device 1011. In some implementations, the external system includes a display device and a user input device.

The processors 1001A-1001N may take many forms, such as ARM processors, X86 processors, and the like.

In some implementations, the computing device 1000 includes at least one of a central processing unit (processor) and a multi-processor unit (MPU).

The processors 1001A-1001N and the main memory 1022 form a processing unit 1099. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network adapter device 1011 provides one or more wired or wireless interfaces for exchanging data and commands between the application system and other devices, such as the system DSS 520 of FIGS. 5A-B. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory 1022 (of the processing unit 1099) from the processor-readable storage medium 1005, the ROM 1004 or any other storage location. During execution of these software programs, the respective machine-executable instructions are accessed by at least one of processors 1001A-1001N (of the processing unit 1099) via the bus 1001, and then executed by at least one of processors 1001A-1001N. Data used by the software programs are also stored in the memory 1022, and such data is accessed by at least one of processors 1001A-1001N during execution of the machine-executable instructions of the software programs. The processor-readable storage medium 1005 is one of, or a combination of two or more of, a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 includes machine-executable instructions (and related data) for an operating system 1012, software programs 1013, and device drivers 1014. In some implementations in which the application system 1000 is a client system, the processor-readable storage medium 1005 includes machine-executable instructions (and related data) for at least one of a client application, a client data synchronization module, an application layer module, an IP messaging module, an IoT device management module, a notification module, and a connectivity layer module. In some implementations in which the application system 1000 is a client system, the processor-readable storage medium 1005 includes at least one local state object.

In some implementations in which the application system 1000 is an application server system, the processor-readable storage medium 1005 includes machine-executable instructions (and related data) for at least one of a server application, a data synchronization module, a server application layer module, a notification module, and a connectivity layer module. In some implementations in which the application system 1000 is an application server system, the processor-readable storage medium 1005 includes at least one local state object.

### 6. Machines

The system and method of the preferred embodiment and variations thereof can be embodied and/or implemented at least in part as a machine configured to receive a computer-readable medium storing computer-readable instructions. The instructions are preferably executed by computer-executable components preferably integrated with the media intelligence platform. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### 7. Conclusion

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
accessing, by one or more processors, a reference state object that corresponds to an account and is usable to update a local state object stored by each device among a plurality of devices that each correspond to the account;
receiving, by the one or more processors, a first message from a first device among the plurality of devices that each correspond to the account, the first message including an update of the local state object stored by the first device;
updating, by the one or more processors and based on the update of the local state object, the reference state object that corresponds to the account; and
providing, by the one or more processors, an update message to a subscribed device among the plurality of devices that each correspond to the account, the subscribed device being subscribed to updates of the reference state object that corresponds to the account, the update message including the updated reference state object that corresponds to the account.

2. The method of claim 1, wherein:
the provided update message that includes the updated reference state object is usable by the subscribed device to update the local state object stored by the subscribed device that corresponds to the account among the plurality of devices that each correspond to the account.

3. The method of claim 1, wherein:
the subscribed device that corresponds to the account is configured to update, based on updated reference state object included in the provided update message, the local state object stored by the subscribed device.

4. The method of claim 1, wherein:
the first device that corresponds to the account is configured to execute an application that generates the update of the local state object stored by the first device.

5. The method of claim 1, wherein:
the first device that corresponds to the account is configured to send, based on an application executing on the first device, the first message that includes the update of the local state object stored by the first device.

6. The method of claim 1, wherein:
the updating of the reference state object is based on a timestamp of the received first message from the first device that corresponds to the account among the plurality of devices that each correspond to the account.

7. The method of claim 1, further comprising:
resolving an inconsistency among multiple first messages received from multiple first devices that each correspond to the account among the plurality of devices that each correspond to the account, the inconsistency being resolved based on timestamps of the multiple first messages.

8. A system comprising:
one or more processors; and
a memory storing instructions that, when executed by the one or more processors, cause the system to perform operations comprising:
accessing a reference state object that corresponds to an account and is usable to update a local state object stored by each device among a plurality of devices that each correspond to the account;
receiving a first message from a first device among the plurality of devices that each correspond to the account, the first message including an update of the local state object stored by the first device;
updating, based on the update of the local state object, the reference state object that corresponds to the account; and
providing an update message to a subscribed device among the plurality of devices that each correspond to the account, the subscribed device being subscribed to updates of the reference state object that corresponds to the account, the update message including the updated reference state object that corresponds to the account.

9. The system of claim 8, wherein:
the provided update message that includes the updated reference state object is usable by the subscribed device to update the local state object stored by the subscribed device that corresponds to the account among the plurality of devices that each correspond to the account.

10. The system of claim 8, wherein:
the subscribed device that corresponds to the account is configured to update, based on updated reference state object included in the provided update message, the local state object stored by the subscribed device.

11. The system of claim 8, wherein:
the first device that corresponds to the account is configured to execute an application that generates the update of the local state object stored by the first device.

12. The system of claim 8, wherein:
the first device that corresponds to the account is configured to send, based on an application executing on the first device, the first message that includes the update of the local state object stored by the first device.

13. The system of claim 8, wherein:
the updating of the reference state object is based on a timestamp of the received first message from the first device that corresponds to the account among the plurality of devices that each correspond to the account.

14. The system of claim 8, further comprising:
resolving an inconsistency among multiple first messages received from multiple first devices that each correspond to the account among the plurality of devices that each correspond to the account, the inconsistency being resolved based on timestamps of the multiple first messages.

15. A non-transitory machine-readable medium storing instructions that, when executed by one or more processors, cause the one or more processors to perform operations comprising:
accessing a reference state object that corresponds to an account and is usable to update a local state object stored by each device among a plurality of devices that each correspond to the account;
receiving a first message from a first device among the plurality of devices that each correspond to the account, the first message including an update of the local state object stored by the first device;
updating, based on the update of the local state object, the reference state object that corresponds to the account; and
providing an update message to a subscribed device among the plurality of devices that each correspond to the account, the subscribed device being subscribed to updates of the reference state object that corresponds to the account, the update message including the updated reference state object that corresponds to the account.

16. The non-transitory machine-readable medium of claim 15, wherein:
the provided update message that includes the updated reference state object is usable by the subscribed device to update the local state object stored by the subscribed device that corresponds to the account among the plurality of devices that each correspond to the account.

17. The non-transitory machine-readable medium of claim 15, wherein:
the subscribed device that corresponds to the account is configured to update, based on updated reference state object included in the provided update message, the local state object stored by the subscribed device.

18. The non-transitory machine-readable medium of claim 15, wherein:
the first device that corresponds to the account is configured to execute an application that generates the update of the local state object stored by the first device.

19. The non-transitory machine-readable medium of claim 15, wherein:
the first device that corresponds to the account is configured to send, based on an application executing on the first device, the first message that includes the update of the local state object stored by the first device.

20. The non-transitory machine-readable medium of claim 15, wherein:
the updating of the reference state object is based on a timestamp of the received first message from the first device that corresponds to the account among the plurality of devices that each correspond to the account.
